(19) United States
(12) Patent Application Publication
(10) Pub. No.: US 2004/0172871 A1
(43) Pub. Date: Sep. 9, 2004

(54) Parking identification system

(76) Inventor: Arkadiy Antonov, Elizabeth, NJ (US)

Correspondence Address: Arkadiy Antonov, 45 Tehama Street, apt 4B, Brooklyn, NY, 11218, US

(21) Appl. No.: 10/376,394

(22) Filed: Mar. 3, 2003

(51) Int. Cl. G09F 21/04

(52) U.S. Cl. 40/591

(57) ABSTRACT

A system for conveying the driver's intent to park his/her vehicle consisting of a sign which is mounted on the vehicle and the means of operating the said sign from the driver's position. The said sign contains a message, which clearly indicates the driver's intent to park.

### BACKGROUND

1. Field of Invention

This invention relates to vehicle parking identification systems, specifically to such systems which are used to convey the driver's intent to park the vehicle to other vehicles' drivers.

2. Description of Prior Art

In the traffic conditions of modern cities, one of the reasons for delays consists of the inability of a driver who wishes to park his car (and is forced to do so while backing up) to convey his intent to the vehicles following him. The distance between the vehicles in real conditions of slow traffic is about 5-10 ft., and the clear space required to perform back-up parallel parking is about two-thirds of the length of the vehicle, which is more than that. Thus, when the driver stops and tries to back up, the distance between him and the following vehicle is too short to make the maneuver. Therefore, the vehicles following him also have to back up, which causes a considerable delay of traffic.

Usage of existing turn signals and hazard lights does not solve the problem, since turning them on may indicate many possible moves, such as turning into a driveway, unloading passengers etc., which do not require the following vehicle to increase the distance. The only solution to this problem would be to create a parking identification system which would clearly indicate the driver's intent to park.

The patent search did not reveal any prior art. Provisionary patent application for the said system was filed on Nov. 13, 2002. The US PTO reference number is 60/425937.

### SUMMARY

The present invention is a parking identification system that consists of a sign which can be turned on and off by the driver. The sign conveys a clear message that the driver intends to park the vehicle.

### OBJECTS AND ADVANTAGES

Accordingly, several objects and advantages of the present invention are:

a) The ability to provide an advance warning to the drivers of following vehicles, hereby facilitating the parking of the vehicle equipped with the device;

b) Reducing the inconvenience to drivers of following vehicles;

c) Decreasing traffic delays, fuel consumption and air pollution;

d) The relative inexpensiveness of the device and the possibility of installing it on existing vehicles without any modification.

### DRAWING FIGURES

FIG. 1 shows the “intent to park” identification sign mounted on the back of a truck. FIG. 2 shows it as a sign on the back of a car's trunk.

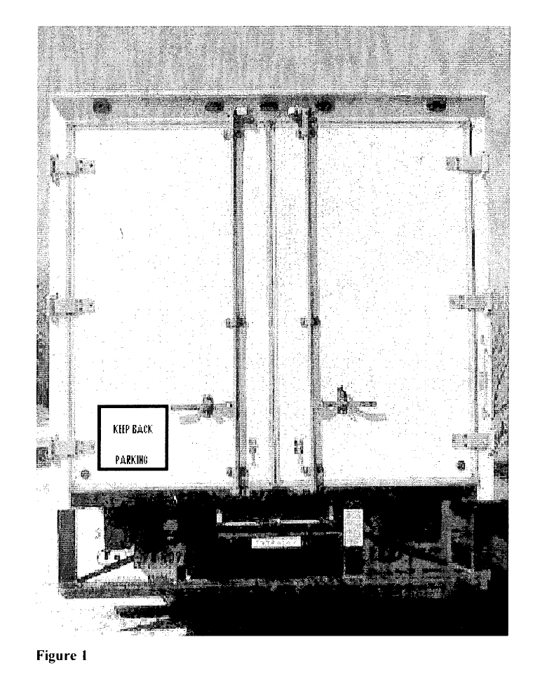

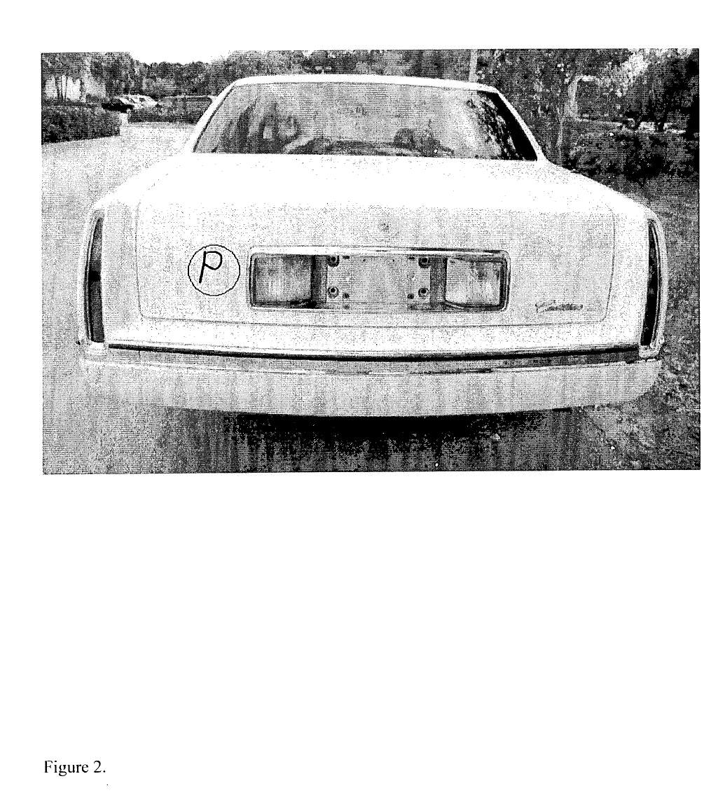

### OPERATION

When approaching the parking space, the driver turns on the switch and the “intent to park” sign starts flashing. After completing the maneuver, the driver turns the sign off.

### Conclusions, Ramifications and Scope

Accordingly, the reader will see that the parking identification system of this invention can be used to facilitate the parking of a vehicle as well as reduce inconvenience to other drivers, traffic delays, fuel consumption and air pollution. The system can be easily installed at a low cost and without any significant modification of the vehicle.

Although the description above contains many specificities, these should not be construed as limiting the scope of the invention but as merely providing of some of the presently preferred embodiments of this invention. For example, the sign can be of other shapes such as circular, oval, trapezoidal, triangular etc., the wording can be different (it just has to clearly confer the intent to park), it can be of certain government-approved shape and color which would clearly identify it as an “intent to park” sign and make the lettering unnecessary, it can be made an integral part of the vehicle, the electrical scheme can be different, the sign can light up instead of flashing, etc.

Thus the scope of the invention should be determined by the appended claims and their legal equivalents, rather than by the examples given.

I claim:

1) A device for conveying the vehicle driver's intent to park the vehicle.

2) That the said device consists of a sign mounted on the vehicle and the means for operating the said sign from the driver's position.

3) That the said sign displays a message or is of such a shape that clearly identifies the driver's intent to park the vehicle.
